(19) United States
(12) Patent Application Publication
(10) Pub. No.: US 2024/0151539 A1
(43) Pub. Date: May 9, 2024

(54) Method and Motor Vehicle for Multimodal Route Planning

(71) Applicant: Bayerische Motoren Werke Aktiengesellschaft, Muenchen (DE)

(72) Inventors: Manuel Schiller, Eichstaett (DE); Julia Schiller, Eichstaett (DE)

(21) Appl. No.: 18/549,786

(22) PCT Filed: Feb. 11, 2022
(86) PCT No.: PCT/EP2022/053431

§ 371 Date: Sep. 8, 2023

(30) Foreign Application Priority Data
Mar. 24, 2021 (DE) 10 2021 107 425.8

(51) Int. Cl. G01C 21/34

(52) U.S. Cl. CPC G01C 21/3423

(57) ABSTRACT

A method for automatic route planning includes recording a navigation destination using a navigation apparatus of a main motor vehicle, wherein the navigation apparatus configured for route planning. The method further includes detecting automatically whether the main motor vehicle is carrying a small vehicle. If so, then a multimodal route to the navigation destination is automatically planned using the navigation apparatus. The multimodal route includes a first route section that is to be traversed using the main motor vehicle, and a second route section that substantially adjoins the first route section at a transfer point, that leads to the navigation destination, and is to be traversed using the small vehicle.

The present application is the U.S. national phase of PCT Application PCT/EP2022/053431 filed on Feb. 11, 2022, which claims priority of German patent application No. 102021107425.8 filed on Mar. 24, 2021, which is incorporated herein by reference in its entirety.

### TECHNICAL FIELD

The present disclosure relates to a method for automatic route planning and to a motor vehicle that is designed for a method of this kind.

### BACKGROUND

Automatic route planning for motor vehicles is in widespread use nowadays and constitutes an important convenience feature. In the light of the increasing volume of traffic, rising fuel prices, restrictions, at least in certain areas, with respect to operating particular types of vehicles or groups of vehicles and the general desire to reduce emissions, there may, however, be a need for further improved flexibility in the transportation and mobility of people.

One approach for this is to use a plurality of different means of transport for reaching a particular destination, which is also referred to as a multimodal route. Planning for a multimodal route is described in DE 10 2014 224 090 A1, for example. In the method described therein, inputs are received, which specify a route start point and a route end point. Data are also retrieved, which relate to a type of vehicle for possible use on the route. Data including at least one attribute of each of one or more possible route waypoints are additionally retrieved, wherein the at least one attribute relates to a parking option for the type of vehicle. Finally, a route is determined between the start point and the end point at least in part by applying the route parameter to the attribute.

The object of the present disclosure is to provide a method and/or apparatus that allows further improved route planning.

### SUMMARY

This object is achieved according to at least some embodiments and implementations described herein.

A first embodiment is a method used for automatic route planning. In other words, the method can be used to plan a route, from a current position or a predefined or recorded start point to a predefined or recording navigation destination, that is intended to be covered using a vehicle. In the method, in particular before or upon the start of the journey or departure, the navigation destination is recorded by a navigation apparatus of a main motor vehicle, said navigation apparatus being designed for route planning. By way of example, this can mean or comprise recording a corresponding user input via an input interface, retrieving corresponding data from a data memory and/or the like.

In a further method step, it is automatically detected whether the main motor vehicle is carrying along a small vehicle. By way of example, this detection can be carried out by a corresponding detection apparatus of the main vehicle, which is connected to a navigation apparatus for the route planning, or by the navigation apparatus itself.

Optionally, a corresponding detection result can be automatically transmitted to, or recorded by, the navigation apparatus.

In the present context, a small vehicle can in principle be any vehicle or any type of vehicle that can be carried along or transported in, on, or with the main motor vehicle. The small vehicle can therefore be, for example, a bicycle, a unicycle, a scooter with or without a drive motor, a Segway Personal Transporter, an E-board, a skateboard and/or the like. By way of example, a small vehicle of this kind can be transported, that is to say carried along, in or with a conventional car that can then function as the main motor vehicle.

If it is detected that the main motor vehicle is carrying along a small vehicle, in a further method step, a multimodal route to the navigation destination is automatically planned by the navigation apparatus. In this case, this multimodal route is planned in such a way that it comprises a first route section that is to be covered using the main motor vehicle, and a second route section that adjoins the first route section at a transfer point, leads to the navigation destination and is to be covered using the small vehicle.

In other words, at least some embodiments provide automatic adaptation of the route planning to respective conditions. Depending on the situation, a multimodal route can, for example, save on time, emissions and costs, reduce the volume of motor vehicle traffic in congested areas, and additionally be beneficial for health. At least some embodiments make the practical implementation of these advantages particularly simple and convenient for a respective user and can reduce the challenge of using the small vehicle for certain parts or sections.

This is the case, since the automatic route planning is carried out or is adapted automatically depending on whether or not the small vehicle is present. A respective user therefore does not have to carry out any manual selection or activation of the multimodal route planning, for example, if they are carrying along the small vehicle in or on the main motor vehicle. By virtue of the fact that the individual route sections are automatically specifically planned for the respective means of transport, that is to say for the main motor vehicle and for the small vehicle being carried along in each case, respectively, and also the transfer point at which there is, or there is intended to be, a change from the main motor vehicle to the small vehicle is determined by the navigation apparatus itself, the entire multimodal route can be automatically optimized with respect to one or more predefined criteria and therefore can be designed to be particularly comfortable and convenient as required or for the respective user. This is possible here with particularly little outlay, since the respective user does not have to manually select the transfer point, for example, and different individual routes are not planned independently of one another, but rather all route sections are planned in combination with one another.

If the navigation apparatus finds a plurality of different possible multimodal routes to the navigation destination, that is to say possible route suggestions, these can be submitted, that is to say presented, to the respective user for selection or confirmation. A corresponding selection or confirmation by a respective user can still be particularly and simple in comparison to conventional solutions.

Furthermore, the navigation apparatus can be designed to, if necessary, automatically replan or update the planned route during the journey, in particular during the journey in the first route section if, for example, a predefined criterion has been met. By way of example, such replanning or updating can take place automatically if, on the basis of recorded current traffic data, there is a traffic jam or some other obstacle in the planned first route section. In such a case, the transfer point can then, for example, be brought forward, that is to say the second route section can be lengthened at the expense of the first route section. The transfer point can, for example, likewise be brought closer to the navigation destination and therefore the second route section can be shortened in favor of the first route section if, on the basis of recorded current weather data, or on the basis of a recorded local weather situation, it is identified that a predefined precipitation criterion or slippery road surface criterion or the like has been met.

The navigation apparatus can also be designed to automatically transmit at least the second route section or corresponding navigation data or navigation information to a navigation device of the small vehicle or a mobile terminal assigned to the respective small vehicle or the respective user, for example a smartphone or the like. Therefore, the course of the second route section can be available to the user in a particularly simple and convenient manner during use of the small vehicle along this second route section, even if the navigation apparatus is part of the main motor vehicle, for example.

The navigation apparatus can be designed, in the event that no small vehicle being carried along is detected or if it is detected that there is no small vehicle being carried along in or on the main motor vehicle, to automatically carry out monomodal route planning, which envisages covering the entire route up to the navigation destination using the main motor vehicle, or multimodal route planning involving public transport.

In one possible configuration, at least one camera of the main motor vehicle is automatically activated, for example by the navigation apparatus, in order to detect the small vehicle. Image data captured by this camera are then recorded and processed in order to identify the small vehicle. By way of example, a conventional image processing algorithm, an artificial neural network trained accordingly for object identification, and/or the like are used for this purpose. By way of example, the small vehicle can be detected in response to the navigation destination being recorded or, optionally again, before the start of the journey, in particular immediately before the start of the journey. If, in the latter case, a small vehicle is detected before or upon the start of the journey that was not detected before, for example during monomodal route planning that has already taken place upon an earlier recording of the navigation destination, in response to this detection, the route can automatically be replanned as a multimodal route, that is to say the multimodal route planning can be carried out despite any route already planned. Using a camera of the main motor vehicle to detect the small vehicle can be expedient, since nowadays many motor vehicles are in any case already equipped with cameras, for example for interior monitoring and/or for recording the surroundings. Therefore, no additional hardware has to then be used for a separate detection apparatus. The camera-image-based detection of the small vehicle additionally allows the small vehicle, or a type of the small vehicle, to be identified. In other words, it is therefore possible to detect, in a particularly reliable manner, which small vehicle, or which type of motor vehicle, is being carried along. This can then be taken into account in the multimodal route planning, for example with respect to a path selection. It is therefore possible, for example, to take into account which paths are permissible for the respectively detected small vehicle, and which are not.

In a further possible configuration, the small vehicle, or the presence thereof, that is to say it being carried along in the main motor vehicle, is detected on the basis of a signal emitted wirelessly by a transmitting apparatus of the small vehicle and received by a receiving apparatus of the main motor vehicle. In other words, the small vehicle can, for example, be detected on the basis of an RFID, Bluetooth, radio or NFC signal, or the like. This can be particularly expedient, since then there optionally does not need to be a direct line of sight between the detection apparatus and the small vehicle or particular light conditions in order to reliably detect the small vehicle. Further data can also be transmitted by the signal in a particularly simple and reliable manner, for example with respect to a type, equipment or a state of charge of the battery of the small vehicle and/or the like. Data of this kind can then also be taken into account in the multimodal route planning by the navigation apparatus. Therefore, it is possible to ensure, for example, that the second route section can be managed by the respective small vehicle, for example in terms of its off-road capability and/or its battery-electric range. By way of example, the signal, on the basis of which the small vehicle is detected, can be automatically requested by the main motor vehicle or the navigation apparatus in response to the navigation destination being recorded. In other words, for example, a corresponding request or read signal can be automatically emitted by the navigation apparatus in order, if the small vehicle is present, to trigger a corresponding response signal, on the basis of which the small vehicle can be detected or identified. This enables further improved convenience of use, since the user does not have to manually activate a corresponding transmitting apparatus of the small vehicle, for example, and additionally avoids the small vehicle or the transmitting apparatus thereof having to emit the signal continuously for it to be detected.

In a further possible configuration, a carrier apparatus installed on the main motor vehicle is detected in order to detect the small vehicle, and the small vehicle is detected on the basis of a weight load occurring when the small vehicle is inserted into the carrier apparatus or a load change caused by the weight of the respective small vehicle. By way of example, the carrier apparatus can be detected optically, by means of a camera of the main motor vehicle and/or for example electrically if the carrier apparatus is connected to an on-board electrical system of the main motor vehicle. A weight or load sensor, which is used for detecting the small vehicle, can also be used for detecting the carrier apparatus. To this end, for example, a weight or a sensor value or measured value caused by the empty carrier apparatus can be stored, for instance in a data memory of the navigation apparatus. By way of example, a weight or an associated sensor value or measured value can also be predefined or stored for the small vehicle or for a plurality of different small vehicles. This can allow combined detection and identification of the small vehicle. In addition, it is possible to detect or identify a plurality of small vehicles being carried along that are successively inserted into the carrier apparatus on the basis of an incremental variation of the weight load. In practice, this is possible in a reliable manner, since, as a rule, a plurality of small vehicles are not inserted into the carrier apparatus at the same time. The detection of the small vehicle on the basis of the weight load can be, or can be carried out, in a particularly simple and reliable manner, since a sensor system used for this purpose can be particularly robust with respect to ambient conditions, visual concealments, and/or the like. By way of example, the sensor system can comprise a pressure sensor, a force sensor, a strain gauge, and/or the like in order to detect the weight load. Such a sensor can, for example, be integrated into a vehicle-side receptacle or holder or an installation point for the carrier apparatus. By way of example, the weight load can also be detected on the basis of an angle of inclination or a change in an angle of inclination, a damper compression, and/or the like of the main motor vehicle. This can then optionally be implemented without additional hardware of the main motor vehicle and therefore in a particularly cost-effective and user-friendly manner. By way of example, corresponding data or measured values can be recorded by the navigation apparatus via an on-board electrical system of the main motor vehicle.

In a further possible configuration, the route and a position of the transfer point are optimized by the navigation apparatus with respect to at least one predefined criterion. By way of example, minimizing a total journey duration can be predefined as such a criterion. To this end, traffic or congestion data, a lower speed in inner-city traffic in comparison to traffic outside of the city, a time required for changing from the main motor vehicle to the small vehicle, and/or the like can be taken into account, for example. Minimizing a proportion of major roads, or even of traffic routes that are permissible for motor vehicles or cars, for the second route section can also be predefined as a criterion. In other words, the route planning can therefore be carried out such that, depending on the type of the respective small vehicle, a proportion of pedestrian or cycle paths is maximized for the second route section, for example. As a result, it is possible to achieve a particularly safe and comfortable driving experience in the second route section. Adhering to a threshold value, which is predefined for second route section, for a maximum length, a maximum or average gradient and/or a maximum incline difference between the transfer point and the navigation destination can also be predefined as a criterion. Limiting these parameters makes it possible to ensure that the respective user can manage the second route section using the small vehicle sufficiently well or particularly easily, which can encourage acceptance and likelihood of use for the multimodal route planning.

Complying with requirements that are predefined for the transfer point, in particular space and safety requirements, can also be predefined as a criterion. Therefore, it is possible to ensure than a simple and safe unloading or offloading of the small vehicle can be carried out at the transfer point. Minimizing a distance between the transfer point and a start of a path that is permissible for the small vehicle but inaccessible for cars and that forms at least part of the second route section can also be predefined as a criterion. Defining or limiting the transfer point in this way makes it possible to make the use of the small vehicle particularly safe and pleasant, which can benefit the acceptance and use of the multimodal route planning.

Minimizing total costs for reaching the navigation destination can also be predefined as a criterion. In this case, for example, costs for a drive energy, that is to say, for instance, electric current for charging a traction battery or gasoline or the like for the main motor vehicle, possibly occurring toll charges, parking fees at the transfer point and/or the like can be taken into account.

In addition to these and/or further criteria, a minimum length of the second route section can always be predefined as a further criterion, for example. As a result, it is possible to achieve improved convenience and improved acceptance of the multimodal route planning by ensuring that the multimodal route planning determines practical route suggestions or solutions for the route planning. Optimization with respect to one or more of the remaining criteria could in some circumstances lead to the second route section only having a length in the region of 100 m, for example, which in practice, with respect to everyday suitability and acceptance of the multimodal route planning, would usually not appear to justify changing to the small vehicle.

For one or more of the criteria mentioned, an optimization threshold value can be predefined or taken into account. By way of example, a threshold value can be predefined for the gradient or the altitude to be managed along the second route section, wherein the route is then optimized in such a way that this optimization threshold value is adhered to, that is to say not exceeded. It is, however, not necessary here to further minimize the corresponding parameter, that is to say the gradient or the altitude in the present case, for example, or to further optimize a particular route with respect to this parameter, if the corresponding parameter value already adheres to the optimization threshold value for the route. In other words, the respective minimization or maximization can therefore only be carried out or prioritized up to the respective predefined optimization threshold value. This makes it possible to find useful, practicable solutions for the optimization problem, that is to say for the route planning and optimization, in a particularly quick and reliable manner.

In a further possible configuration, a time duration required for unloading or offloading the small vehicle from the main motor vehicle is automatically determined. This time duration is then automatically taken into account in the route planning. By way of example, the required time duration can be learned by the navigation apparatus from past multimodal journeys. In this case, the required time can be, or can have been, broken down according to user, type of small vehicle, number of small vehicles, time of the day, weather conditions, type of transfer point and/or the like. This allows particularly accurate, robust and reliable route planning and optimization.

In general, one or more criteria or conditions can be predefined that can be automatically checked or evaluated before the actual route planning and that determine whether the multimodal route planning is even carried out or proposed to a user, or whether instead, possibly despite a small vehicle being carried along having been detected, for example, different route planning is carried out that disregards the small vehicle and the use thereof. For example, the latter can be multimodal route planning that only envisages the use of the main motor vehicle or can be park and ride route planning, which envisages using the main motor vehicle and mass public transport, for example a bus or a train, for certain sections in each case. By way of example, weather conditions can be taken into account as such criteria or conditions, possibly depending on individual user preferences. For example, the multimodal route planning can therefore be carried out, that is to say the small vehicle and the use thereof are taken into account only if the current weather conditions, or the weather conditions expected up to the navigation destination, fall within a predefined spectrum, or if particular predefined weather conditions, such as snowfall, black ice, negative temperatures, heat, high ozone pollution, high UV values and/or the like are not present, that is to say are not there.

Taking criteria or conditions of this kind into account can lead to improved safety and further improve acceptance and user convenience.

As a further approach for this, provision is made, according to a further possible configuration, for the multimodal route planning involving the small vehicle and the use thereof for a section of the route to be only carried out if the total distance to the navigation destination is shorter than a predefined distance threshold value. By way of example, a maximum distance of km, 50 km, 100 km, 150 km or several 100 km can be predefined as such a distance threshold value. Other smaller, intermediate, or larger values are also possible, however. Taking a distance threshold value of this kind into account makes it possible to rule out situations from the multimodal route planning in which said route planning is not useful. This can, for example, relate to a vacation journey, for example the journey to a hotel at a resort or the like. In such a case, in practice it is possibly not useful to stop the main motor vehicle at a transfer point that is some distance from the navigation destination, that is to say, for example, from the respective hotel, since luggage has to be unloaded and the navigation destination is intended to be used as the starting point and the destination point for further journeys.

In a further possible configuration, occupants of the main motor vehicle are automatically identified by a recording apparatus of the main motor vehicle. The multimodal route planning involving the small vehicle is only automatically carried out if a predefined criterion with respect to the number and/or the identity of the identified occupants has been met, in particular if the number of identified people at most corresponds to the number of detected small vehicles, if the identified occupants comprise a particular person or group of people and/or do not comprise a particular person, type of person or group of people. By way of example, the recording apparatus can be or comprise an interior camera of the motor vehicle. The occupants can then possibly be automatically identified on the basis of corresponding camera images and/or on the basis of personal mobile electronic devices of the occupants. The convenience of use can be further improved as a result of the configuration proposed here. By way of example, route planning or route suggestions that would lead to a separation or division of a group of people traveling together in the main motor vehicle, or would mean use of the small vehicle by people with physical impairments or infants, can therefore be avoided, in particular without a respective user or vehicle occupant having to explicitly manually deactivate the multimodal route planning for this purpose.

The different criteria mentioned for optimizing the route and/or for deciding whether the multimodal route planning is even carried out or proposed can be automatically weighted, predefined or selected depending on the situation or conditions, and/or by a user, for example.

This allows a particularly good level of flexibility and adjustment time in order to ultimately allow a particularly convenient and needs-based use of the present embodiment.

In a further possible configuration, the conditions in which a user of the main motor vehicle actually uses a small vehicle that is being carried along are automatically learned by a machine learning apparatus, in particular of the main motor vehicle or the navigation apparatus. The multimodal route planning is then only automatically carried out if one, a plurality, or all of these conditions have been met. In other words, connections between, or combinations of, different parameters, situations, weather conditions, times of the day, days of the week, times of the year, particular start points, particular navigation destinations, particular people or occupants in the main motor vehicle, some other load on the main motor vehicle and/or the like, which have led to the small vehicle being used in the past or will lead to such a use in the future, can therefore be learned by the machine learning apparatus. By way of example, the machine learning apparatus can therefore be trained, on the basis of the data mentioned and/or other data, to automatically predict a respective probability that the respective user wants to use, or will use, the small vehicle during the respective journey, in particular if a corresponding multimodal route is proposed by the navigation apparatus. The multimodal route planning can then be automatically carried out according to this probability or if a corresponding probability threshold value is reached or exceeded. Otherwise, that is to say if corresponding conditions have not been met or satisfied, or the particular probability is below the probability threshold value, in contrast, for example as described, different route planning can automatically be carried out. In this way, the convenience of use of the present embodiments can be further improved and can be individualized with particularly little outlay on the part of the user, that is to say can be adapted to personal characteristics, preferences, or habits of the respective user.

A further aspect is a motor vehicle that has a detection apparatus for automatically detecting a small vehicle that is being carried along in or on the motor vehicle, and a navigation apparatus, which is coupled thereto, for automatically planning a multimodal route to a navigation destination upon a small vehicle being detected. The motor vehicle is designed to carry out, automatically or partly automatically, at least one variant of the method discussed above. The motor vehicle can therefore be the main motor vehicle mentioned in conjunction with the method discussed above. Accordingly, the motor vehicle can have some of all of the characteristics and/or features mentioned in conjunction with the method, in particular, those of the main motor vehicle mentioned therein.

Further features may emerge from the claims, the FIGS. and the description of the figures. The features and feature combinations mentioned in the description above and the features and feature combinations shown in the description of the figures below and/or in the figures alone are able to be used not only in the respectively indicated combination but also in other combinations or on their own without departing from the scope of the disclosure.

### BRIEF DESCRIPTION OF THE DRAWINGS

FIG. 1 shows a sectional schematic overview representation to illustrate a method for multimodal route planning; and

FIG. 2 shows a sectional schematic representation of a motor vehicle that is carrying along a small vehicle and is designed for multimodal route planning.

### DETAILED DESCRIPTION

In the figures, identical and functionally identical elements are provided with the same reference symbols.

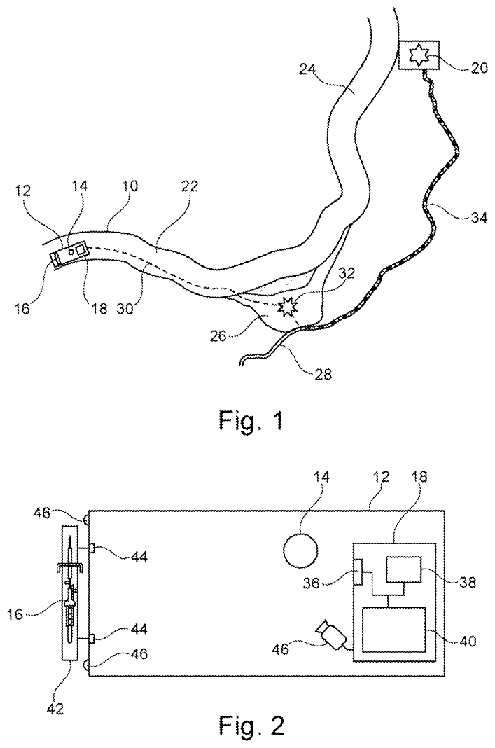

FIG. 1 shows schematic overview representation to illustrate multimodal route planning. A road 10 is shown here, on which a main motor vehicle 12 is located at an initial or start point. This main motor vehicle 12 is in this case used by a driver 14 and is carrying along a small vehicle 16. The main motor vehicle 12 is designed for automatic, needs-based multimodal route planning and has a navigation apparatus 18 for this purpose.

Before the start of a journey, the driver 14 can input or predefine a respective navigation destination 20, for example via a corresponding interface 36 (see FIG. 2) of the navigation apparatus 18. It can then be automatically detected that the small vehicle 16 is being carried along in or on the main motor vehicle 12. In addition, the navigation apparatus 18 can record further data, for example regarding the main motor vehicle 12, the small vehicle 16, the driver 14, current weather conditions, current traffic conditions and/or the like. In this case, the navigation apparatus 18 can, for example, ascertain that a first road section 22 of the road 10 is classified as a main road, expressway or freeway or the like and at present, or for a time period following a planned departure time, only has a relatively low volume of traffic; in contrast, a second route section 24 closer to the navigation destination 20 is for example classified as an inner-city area and/or at present, or during a planned travel time, has a relatively high volume of traffic. Furthermore, the navigation apparatus 18 can ascertain that there is a parking area 26 along the road or between a start point and the navigation destination 20, for example, which parking area, on the basis of at least one predefined criteria, comes into consideration as a transfer point 32 at which the driver 14 can change from the main motor vehicle 12 to use the small vehicle 16. In addition, the navigation apparatus 18 can ascertain that the road 10 at least comes close to a pedestrian and cycle path 28, which also leads to the navigation destination 20, at at least one point, in the present case in the region of the parking area 26.

On the basis of these data, the navigation apparatus 18 can then carry out automatic multimodal route planning. The navigation apparatus 18 in this case plans a multi-part route from the start or initial point to the navigation destination 20, which route comprises a first route section 30 and a second route section 34 in the present case. The first route section 30 leads from the start or initial point to the transfer point 32 and, according to the multimodal route planning, is to be covered using the main motor vehicle 12. The second route section 34 leads from the transfer point 32 to the navigation destination 20 and is to be covered using the small vehicle 16.

A prerequisite for this multimodal route planning being carried out is that the small vehicle 16 has to be carried along in or on the main motor vehicle 12. In other words, it is initially automatically detected whether, or that, the small vehicle 16 is being carried along. In order to elucidate this in greater detail, FIG. 2 shows an exemplary schematic representation of the main motor vehicle 12. The navigation apparatus 18 of said main motor vehicle in this case has the interface 36, via which, for example, user information, data or signals are recorded and a planned route, a route suggestion or corresponding navigation instructions can be output—whether it be to the driver 14, the small vehicle 16 and/or to an electronic terminal of the driver 14, for example. In order to carry out the multimodal route planning, the navigation apparatus 18 additionally comprises a processor apparatus 38 and a computer-readable data memory 40 that is connected thereto. An operating or computer program can be stored in this data memory 40, which program represents, that is to say encodes or implements the sequences or measures, and is able to be executed by the processor apparatus 38 in order to carry out a corresponding method for multimodal route planning or in order to cause said method to be carried out.

In the present case, a carrier apparatus 42 is installed on the main motor vehicle 12, by means of which carrier apparatus the small vehicle 16 being carried along is transported. A plurality of different types and configurations are possible here. If the small vehicle 16 is a bicycle, for example, the carrier apparatus 42 can for example be a bicycle rack.

Installation of the carrier apparatus 42, but at least insertion or loading of the small vehicle 16 into or onto the carrier apparatus 42 can be detected by a corresponding sensor system. To this end, the main motor vehicle 12 can have at least one load sensor 44, which is coupled to the carrier apparatus 42 or an installation point, provided therefor, of the main motor vehicle 12, and/or a camera 46. By way of example, the latter can be or comprise an interior camera and/or a surroundings camera. In particular, it is possible to also recognize or identify the driver 14 and to possibly ascertain a number of further occupants of the main motor vehicle 12 using said interior camera.

Overall, the described examples therefore show how multimodal route planning can be implemented for a motor vehicle when a further means of transport is carried along.

### LIST OF REFERENCE SIGNS

10 road
12 main motor vehicle
14 driver
16 small vehicle
18 navigation apparatus
20 navigation destination
22 first road section
24 second road section
26 parking area
28 pedestrian and cycle path
30 first route section
32 transfer point
34 second route section
36 interface
38 processor apparatus
40 data memory
42 carrier apparatus
44 load sensor
46 camera

1.-10. (canceled)

11. A method for automatic route planning, comprising:
recording a navigation destination using a navigation apparatus of a main motor vehicle, said navigation apparatus configured for route planning,
detecting automatically whether the main motor vehicle is carrying a small vehicle, and,
responsive to detecting that the main motor vehicle is carrying the small vehicle, automatically planning a multimodal route to the navigation destination using the navigation apparatus, said route comprising a first route section that is to be traversed using the main motor vehicle, and a second route section that substantially adjoins the first route section at a transfer point, that leads to the navigation destination, and is to be traversed using the small vehicle.

12. The method as claimed in claim 11, further comprising:
automatically activating a camera of the main motor vehicle, and processing image data captured by said camera in order to detect the small vehicle.

13. The method as claimed in claim 11, wherein:
the small vehicle is detected at least in part based on a signal emitted wirelessly by a transmitting apparatus of the small vehicle and received by a receiving apparatus of the main motor vehicle.

14. The method as claimed in claim 11, wherein:
a carrier apparatus installed on the main motor vehicle and configured to receive the small vehicle is detected in order to detect the small vehicle.

15. The method as claimed in claim 14, wherein the carrier apparatus is configured to support a number of small vehicles, and wherein the number of small vehicles is detected on the basis of a weight load occurring when one or more of the small vehicles are supported on the carrier apparatus.

16. The method as claimed in claim 11, wherein:
the route and a position of the transfer point are at least partially optimized by the navigation apparatus with respect to at least one of the following criteria:
minimizing a total journey duration, minimizing a proportion of major roads for the second route section, adhering to a threshold value that is predefined for the second route section, adhering to a threshold value that is predefined for the second route section for a maximum length, adhering to a threshold value that is predefined for the second route section gradient and/or incline difference, complying with minimum space and safety requirements that are predefined for the transfer point, minimizing a distance between the transfer point and a start of a path that is permissible for the small vehicle but inaccessible for cars and that forms at least part of the second route section, and minimizing total costs.

17. The method as claimed in claim 11, wherein:
the route and a position of the transfer point are selected by the navigation apparatus based at least in part on a criterion of reducing a total journey duration.

18. The method as claimed in claim 11, wherein:
the route and a position of the transfer point are selected by the navigation apparatus based at least in part on a criterion of reducing a proportion of major roads for the second route section.

19. The method as claimed in claim 11, wherein:
the route and a position of the transfer point are at least partially optimized by the navigation apparatus with respect to at least one of the following criteria:
adhering to a threshold value that is predefined for the second route section for a maximum length, and adhering to a threshold value that is predefined for the second route section gradient and/or incline difference.

20. The method as claimed in claim 11, wherein:
the route and a position of the transfer point are selected at least partially on a basis of complying with minimum space and safety requirements that are predefined for the transfer point.

21. The method as claimed in claim 11, wherein:
the route and a position of the transfer point are selected by the navigation apparatus at least partially based on minimizing a distance between the transfer point and a start of a path that is permissible for the small vehicle but inaccessible for cars and that forms at least part of the second route section.

22. The method as claimed in claim 11, wherein:
the route and a position of the transfer point are selected by the navigation apparatus at least partially based on minimizing total costs.

23. The method as claimed in claim 11, further comprising:
determining automatically a time duration estimation for unloading or offloading the small vehicle from the main motor vehicle; and
planning the multimodal route base at least in part on the time duration estimation.

24. The method as claimed in claim 11, wherein:
planning the multimodal route only if the total distance to the navigation destination is shorter than a predefined distance threshold value.

25. The method as claimed in claim 11, wherein:
a number of and/or identity of occupants of the main motor vehicle is automatically identified by an apparatus of the main motor vehicle and the multimodal route planning involving the small vehicle is only automatically carried out if a predefined criterion with respect to the number and/or the identity of the identified occupants has been met.

26. The method as claimed claim 11, wherein:
conditions in which a user of the main motor vehicle uses a small vehicle supported by the main motor vehicle are automatically learned by a machine learning apparatus, and the multimodal route planning is only automatically carried out if one or more of the conditions have been met.

27. A motor vehicle, comprising:
a detection apparatus configured to automatically detecting a small vehicle supported by the motor vehicle; and
a navigation apparatus operably coupled to the detection apparatus, and configured to automatically planning a multimodal route to a navigation destination responsive to a small vehicle being detected, said route comprising a first route section that is to be traversed using the main motor vehicle, and a second route section that substantially adjoins the first route section at a transfer point, that leads to the navigation destination, and is to be traversed using the small vehicle.
